(19) United States
(12) Patent Application Publication
(10) Pub. No.: US 2005/0074381 A1
(43) Pub. Date: Apr. 7, 2005

(54) Impurity removal

(76) Inventors: Malcolm Timothy Frost, Kenmore Hills (AU); John Gregory Sheehan, Chapel Hill (AU)

Correspondence Address: RODMAN RODMAN, 7 SOUTH BROADWAY, WHITE PLAINS, NY, 10601, US

(21) Appl. No.: 10/363,520

(22) PCT Filed: Sep. 7, 2001
(86) PCT No.: PCT/AU01/01125

(30) Foreign Application Priority Data
Sep. 8, 2000 (AU) PQ 9999

(51) Int. Cl. C02F 11/18; C25C 3/04

(52) U.S. Cl. 423/155; 423/158

(57) ABSTRACT

Calcium is precipitated from a solution containing calcium chloride by a process which includes reacting the calcium chloride with magnesium carbon hydrate under reaction conditions to form a calcium carbonate precipitate.

### TECHNICAL FIELD

The present invention relates to a process for precipitating calcium from a solution containing calcium chloride.

### BACKGROUND ART

Substantially pure magnesium metal can be electrolytically produced from magnesium chloride with evolution of chlorine gas. However, if hydrated magnesium chloride is used as the feed to the electrolytic cell, the efficiency of the cell significantly decreases over a short period of time as oxides of magnesium are formed which corrode the electrodes and produce a sludge which must be periodically removed from the cell. Accordingly, it is desirable to produce substantially pure anhydrous magnesium chloride which is suitable for electrolytic production of magnesium metal.

Magnesium chloride feed for electrolytic cells can be obtained from a number of natural sources including magnesite, magnesium chloride rich brines, sea water and asbestos tailings. Most, if not all, sources of magnesium chloride contain low levels of calcium. If the calcium subsequently forms part of the feed to an electrolytic magnesium cell it can accumulate in the cell and, if not removed, con substantially reduce the energy efficiency of the production of magnesium metal. Additionally, increased concentrations of calcium chloride in the cell electrolyte can move the electrolyte density outside the optimum operating range. Calcium in the cell feed can also be present in part as oxygen containing compounds, such as calcium oxide, which increases the quantity of sludge formed in the cell. This sludge can accumulate Co concentrations that adversely effect the energy efficiency of the cell, requiring rectification by cell desludging.

One method of producing anhydrous magnesium chloride is often referred to as carbochlorination and involves heating magnesium oxide with carbon and chlorine and results in any calcium present being converted to calcium chloride. If the resulting mixture is fed into an electrolytic cell, the calcium chloride accumulates in the cell electrolyte, while the magnesium chloride is electrolysed to magnesium and chlorine. The calcium chloride can accumulate to levels which effect the cell energy efficiency and increases the accumulation of sludge in the cell. In order to minimise these effects the calcium chloride is removed from the cell by partial removal of the electrolyte. This results in the consequential loss of magnesium chloride and other components of the electrolyte which must then be replaced The electrolyte and sludge which is removed requires substantial subsequent processing for sound environmental disposal or may require storage in an environmentally sound enclosure.

An alternative method for producing anhydrous magnesium chloride involves dehydrating magnesium chloride hydrates by passing hot dry hydrogen chloride gas over the magnesium chloride hydrate. Calcium in the magnesium chloride hydrate remains as calcium chloride with similar problems being experienced in subsequent electrolysis to those experienced with anhydrous magnesium chloride produced by carbochlorination.

Another method of producing anhydrous magnesium chloride involves ammoniation of magnesium chloride in an organic solvent to form magnesium chloride hexammoniate followed by calcination of the magnesium chloride hexammoniate. The resulting anhydrous magnesium chloride contains tolerable levels of calcium for electrolytic production of magnesium metal because there is a substantial absence of precipitation of calcium salts during the ammoniation of magnesium chloride. Amnoniation processes for the production of anhydrous magnesium chloride are therefore desirable from this perspective. However, because economic production of magnesium chloride hexammoniate requires re-use of various process chemicals, the concentration of calcium progressively increases with the result that the efficiency of the ammoniation process eventually deteriorates. Accordingly, it is desirable to periodically or continuously remove calcium from the organic solvent used in the ammoniation processes for forming anhydrous magnesium chloride.

U.S. Pat. No. 3,433,604 discloses a process for removal of calcium and boron which involves the use of organic extraction agents, namely substituted catechols and aliphatic vicinal diols.

U.S. Pat. No. 4,364,909 discloses a process for calcium removal which involves ion exchange with a crystalline synthetic zeolite U.S. Pat. No. 4,364,909 also discloses a process for calcium removal which involves treatment with excess sulphate ions which suppresses the solubility of calcium ions. Calcium sulphate is only slightly soluble in water; whereas, magnesium sulphate is highly soluble.

Australian Patent No. 665722 discloses two methods for calcium removal: One method involves the use of a steam stripping column to form a concentrated solution of calcium chloride. The second method involves mixing a solution of magnesium bicarbonate with a solution containing calcium chloride and heating the mixture to precipitate calcium carbonate. The second method provides for efficient removal of calcium chloride but suffers from a significant drawback, namely the stability of magnesium bicarbonate. Magnesium bicarbonate is metastable, will convert to solid phase over time, and requires storage at below about 18° C.

### SUMMARY OF THE INVENTION

The present invention provides a process for precipitating calcium from a solution containing calcium chloride, the process including the step of reacting the calcium chloride with magnesium carbonate hydrate under reaction conditions to form a calcium carbonate precipitate.

Preferably, the magnesium carbonate hydrate is magnesium carbonate trihydrate or magnesium carbonate pentahydrate. The magnesium carbonate hydrate may be a mixture of magnesium carbonate hydrates. More preferably, the magnesium carbonate hydrate is magnesium carbonate trihydrate. Preferably, the magnesium carbonate hydrate takes the form of a slurry Preferably, the magnesium carbonate hydrate slurry is produced by treating a magnesia slurry with a source of carbon dioxide. Preferably, the magnesia slurry is a slurry of slaked magnesia. Preferably, the slurry is treated with carbon dioxide by sparging with gaseous carbon dioxide or a gaseous mixture which contains carbon dioxide, for example, a carbon dioxide/air mixture. Alternatively, the slurry may be treated with liquid carbon dioxide.

By comparison with the prior art technique of mixing a solution of magnesium bicarbonate with a solution containing calcium chloride, at least preferred embodiments of the present invention are advantageous in that magnesium carbonate hydrate is more stable than magnesium bicarbonate, a more concentrated slurry of magnesium carbonate hydrate can be formed which facilitates reduced capital and operating expenses, and temperature control in not critical.

The present invention finds particular, but not exclusive, application in the removal of calcium impurity in ammoniation processes for forming anhydrous magnesium chloride.

### EXAMPLE

### Comparative Example

### Calcium Removal from Recycled Glycol Using Magnesium Bicarbonate

Into a 3-neck, 2 litre round bottom flask fitted with a magnetic stirrer bar, thermometer and condenser and some magnesium chloride was placed 900 grams of ethylene glycol containing calcium chloride and some magnesium chloride. The flask was evacuated with a vacuum pump to 50 mm Hg and ethylene glycol was evaporated at 150° C. from the mixture over a period of 5 hours. At the completion of the evaporation 100 g of solution remained which was assayed by EDTA titration and found to contain 171 g/kg calcium chloride and 46 g/kg magnesium chloride in ethylene glycol. This solution was maintained at 100° C.

A separate 1 litre flat bottom culture flask was fitted with a 3-neck lid and an overhead stirrer with a stainless steel impellor in addition to a carbon dioxide sparging tube. This apparatus was placed in a refrigerated water bath and 500 grams of deionised water was added to the flask which was cooled to 15° C. The water was then sparged with carbon dioxide and over a period of two hours 15.8 grams of finely powdered magnesium oxide was added to the water carbon dioxide mixture Carbon dioxide was added at the rate of 250 millilitres per minute to ensure an excess to the actual requirement. During the magnesium oxide addition the temperature of the liquid was carefully maintained at 15° C. The resulting liquor was analysed and found to contain 14.3 grams/kilogram of magnesium (as magnesium bicarbonate).

To 90 grams of the concentrated calcium chloride magnesium chloride ethylene glycol solution was added 253 grams of the magnesium bicarbonate solution over a period of 30 minutes. A precipitate formed immediately on addition of the magnesium bicarbonate. The mixture was maintained at 100° C. throughout the magnesium bicarbonate addition and for a further 15 minutes on completion of addition.

The contents of the flask, which was a mixture of calcium carbonate solids and magnesium chloride, ethylene glycol and water in solution was placed into a Buchner funnel fitted with a filter paper. The solids filtered readily and were then washed with 50 grams of water.

The filtered liquor was assayed by atomic absorption spectroscopy which indicated that 91% of the calcium in the concentrated calcium chloride magnesium chloride ethylene glycol solution had been precipitated

### Example 1

### Continuous Removal of Calcium from Glycol, Magnesium Chloride, Calcium Chloride Solution

Into a 2 litre glass vessel (vessel A), a slurry containing 6.8% w/w magnesia was added at the rate of 1.1 kgh⁻¹ via a peristaltic pump. Vessel A had been charged with some magnesium carbonate trihydrate slurry having a pH of 7.4 at room temperature which had been produced previously Vessel A was fitted with a pH probe and was continuously agitated with a 40 mm impeller at a speed of 1600 rpm. Under atmospheric conditions, a gaseous mixture of 25% vol humidified air and carbon dioxide was sparged through the contents of vessel A at 1.1 times the stoichiometric requirement for magnesia conversion to magnesium carbonate. The pH of vessel A was maintained at around 7.5. Temperature measurements taken throughout indicated the contents of vessel A ranged between 52° C. and 55° C. The contents of vessel A were allowed to overflow into a 1 litre agitated vessel (vessel B) which was also fitted with a pH probe and a carbon dioxide/air sparger. vessel B was agitated at 1000 rpm. The pH of vessel B was maintained at around 7.1 with carbon dioxide/air sparging and the temperature varied between 41° C. and 48° C. samples of the slurry were taken from vessel B and analysed X-ray diffraction analysis of the solids. The results indicated that the major species was magnesium carbonate trihydrate.

The contents of vessel B were allowed to overflow into another 2 litre agitated glass vessel (vessel C). Into vessel C was also added a solution containing 5.1% w/w calcium chloride, 5.95% w/w magnesium chloride, water and glycol at the rate of 2.4 kgh⁻¹. Again, the contents of vessel C were allowed to overflow into another agitated vessel (vessel D). Samples were taken of the contents of vessel D for calcium analysis by atomic emission spectroscopy. The results of the analysis demonstrated that 90% of the calcium in the glycol, water, calcium chloride, magnesium chloride solution added to vessel C had been precipitated from solution as calcium carbonate.

### Example 2

### Continuous Removal of Calcium from Aqueous Solution

Into a rubber lined vessel (vessel 1) having a total working volume of 0.4 m, a slurry containing 17-37% (w/w) calcined magnesia in water was continuously added at rates between 25 and 53 kgh⁻¹. The excess from vessel 1 was allowed to overflow into a second rubber lined vessel (vessel 2) which had a total working volume of 0.2 m³. Vessels 1 and 2 were each fitted with an agitator equipped with a variable speed motor, a pH probe and a lance for sparging the contents with carbon dioxide Potable water was also added to vessel 1 at rates between 20 and 86 litres per hour. The contents of the vessels were continuously sparged under atmospheric conditions with a mixture of gaseous carbon dioxide and air. The carbon dioxide/air mixture was added at the rate of 12-54 kgh⁻¹ at ambient temperature and 125 kPa to ensure an excess to the stoichiometric requirement. The pHs of the vessels were maintained between 6.8 and 7.8 and the temperatures varied between 35° C. to 56° C. A sample of the slurry was taken from vessel 2 and the solids were analysed by X-ray diffraction. The results of the analysis indicated the solids were 100% magnesium carbonate trihydrate. The slurry discharged from vessel 2 varied between 11% w/w and 24% w/w solids.

The magnesium carbonate trihydrate slurry in vessel 2 was allowed to overflow into a third vessel (vessel 3) which was fitted with an overhead agitator. An aqueous solution containing 14-15% (w/w) calcium chloride was also added to this vessel at the rate of 44-107 kgh⁻¹. The contents of vessel 3 was allowed to overflow into a fourth agitated vessel (vessel 4). The contents of vessel 4 were pumped into a storage vessel (vessel 5) prior to filtration in a filter press. The contents of vessel 5 were readily filtered. Filtrate samples were assayed for calcium by atomic absorption spectroscopy which indicated that 94 to 99.9%, with an average of 99.6%, of the calcium present in the aqueous calcium chloride solution had been removed as calcium carbonate precipitate.

### Example 3

### Continuous Removal of Calcium from Solution

Into a rubber lined vessel (vessel 1) having a total working volume of 0.4 m³, a slurry containing 8-27% (w/w) calcined magnesia in water was continuously added at rates between 43 and 96 kgh⁻¹. The excess from vessel 1 was allowed to overflow into a second rubber lined vessel (vessel 2) which had a total working volume of 0.2 m³. Vessels 1 end 2 were each fitted with an agitator equipped with a variable speed motor, a pH probe, and a lance for sparging the contents with carbon dioxide. Potable water was also added to vessel 1 at rates between 40 litres per hour and 100 litres per hour. The contents of vessels were continuously sparged under atmospheric conditions with a mixture of gaseous carbon dioxide and air. The carbon dioxide/air mixture was added at the rate of 30 m³h⁻¹ at ambient temperature and 125 kPa to ensure an excess to the stoichiometric requirement. The temperatures of the vessels varied between 35° C. and 50° C. The pHs of the vessels were maintained between 7.0 and 7.9 and the slurry residence time in the vessels was 1-3.6 hours. The resulting slurry was a hydrated magnesium carbonate slurry containing 20% (w/w) solids where all the magnesia had been converted to magnesium carbonate trihydrate.

Into a rubber lined, agitated vessel (vessel 3) which had a working volume of 1.2 m³ was added at ambient temperature at a rate of approximately 240 kgh⁻¹, a solution containing 6.15% wlw calcium chloride, 8.47% w/w magnesium chloride, 41.7% w/w glycol, 41.4% w/w water and other chloride salts. The hydrated magnesium carbonate slurry from vessel 2 was also added to vessel 3 at the rate of 150 kgh⁻¹, which provided an excess to the actual requirement. The contents of vessel 3 were allowed to overflow into another rubber lined, agitated vessel (vessel 4) having a total working volume of 1.2 m³ giving a total contact time between the magnesium carbonate trihydrate slurry and the solution of glycol, water, calcium chloride and magnesium chloride of 3.5-5.0 hours. The temperature of the vessels ranged between 30 and 35° C. Vessels 3 and 4 contained a slurry of 4-5% (wlw) solids. The slurry was a mixture of calcium carbonate and magnesium carbonate trihydrate in a solution of magnesium chloride, calcium chloride, glycol and water. The slurry was pumped into a storage vessel (vessel 5) prior to filtration in a press filter.

The contents of vessels 3 and 4 were readily filtered. Filtrate samples were assayed for calcium by atomic absorption spectroscopy which indicated that 78-96%, with an average of 81%, of the calcium present in the original solution added to vessel 3 had been removed as calcium carbonate precipitate.

1. A process for precipitating calcium from a solution containing calcium chloride, the process including the step of reacting the calcium chloride with magnesium carbonate hydrate under reaction conditions to form a calcium carbonate precipitate.

2. A process as claimed in claim 1 wherein the magnesium carbonate hydrate is a mixture of magnesium carbonate hydrates.

3. A process as claimed in claim 1 wherein the magnesium carbonate hydrate is magnesium carbonate trihydrate, magnesium carbonate pentahydrate, or a mixture thereof.

4. A process as claimed in claim 1 wherein the magnesium carbonate hydrate is magnesium carbonate trihydrate.

5. A process as claimed in any one of the preceding claims wherein the magnesium carbonate hydrate is in the form of a slurry.

6. A process as claimed in claim 1 wherein the magnesium carbonate hydrate is in the form of a slurry formed by treating a magnesia slurry with a source of carbon dioxide.

7. A process as claimed in claim 6 wherein the magnesia slurry is a slurry of slaked magnesia.

8. A process as claimed in claim 6 or claim 7 wherein the magnesium carbonate hydrate is formed by sparging the magnesia slurry with gaseous carbon dioxide or a gaseous mixture containing carbon dioxide.

9. A process as claimed in claim 6 or claim 7 wherein the magnesium carbonate hydrate is formed by sparging the magnesia slurry with a gaseous carbon dioxide/air mixture

10. A process as claimed in claim 6 or claim 7 wherein magnesium carbonate hydrate is formed by treating the magnesia slurry with liquid carbon dioxide.

11. A process as claimed in any one of the preceding claims wherein the solution containing calcium chloride is a process stream from the production of anhydrous magnesium chloride by ammoniation of magnesium chloride.
